(19) United States
(12) Patent Application Publication
(10) Pub. No.: US 2010/0052424 A1
(43) Pub. Date: Mar. 4, 2010

(54) METHODS AND APPARATUS FOR INTEGRATED CIRCUIT HAVING INTEGRATED ENERGY STORAGE DEVICE

(76) Inventors: William P. Taylor, Amherst, NH (US); P. Karl Scheller, Bow, NH (US); Andrea Foletto, Annecy (FR)

Correspondence Address: DALY, CROWLEY, MOFFORD & DURKEE, LLP, SUITE 301A, 354A TURNPIKE STREET, CANTON, MA, 02021-2714, US

(21) Appl. No.: 12/198,191

(22) Filed: Aug. 26, 2008

(51) Int. Cl. H02J 7/34

(52) U.S. Cl. 307/45

(57) ABSTRACT

Methods and apparatus for a sensor to provide a sensor output, an integrated circuit module formed at least partially on a substrate to receive the sensor output and provide an IC output signal, an output circuit having a voltage input to receive a voltage supply signal via a switch element and a signal input to receive the IC output signal and an output to provide a voltage output signal, and an integrated power storage element coupled to the voltage input of the output circuit to provide power during an interruption of the voltage supply signal, wherein the power storage element includes at least one layer generally parallel to the substrate.

### BACKGROUND

As is known in the art, there are a variety of sensors that are useful for particular applications. For example, magnetic sensors are useful to detect movement, such as rotation, of an object of interest. Sensor devices can include a supply voltage provided to a regulator for powering circuitry on the device. Small scale power interruptions of the voltage supply can result in unstable output states of the device.

### SUMMARY

Exemplary embodiments of the invention provide methods and apparatus for an integrated circuit having an integrated power storage element to maintain an output of the integrated circuit during relatively small power interruptions. With this arrangement, the output state of a sensor/device can be maintained in the presence of power interruptions due to loose wires, connections, user manipulation, vibration, etc. While exemplary embodiments of the invention are shown and described in conjunction with certain circuits, sensors, and configurations, it is understood that embodiments of the invention are applicable to integrated circuits in general for which it is desirable to maintain power during supply voltage interruptions.

In one aspect of the invention, an integrated circuit comprises a sensor to provide a sensor output, an integrated circuit module formed at least partially on a substrate to receive the sensor output and provide an IC output signal, an output circuit having a voltage input to receive a voltage supply signal via a switch element and a signal input to receive the IC output signal and an output to provide a voltage output signal, and an integrated power storage element coupled to the voltage input of the output circuit to provide power during an interruption of the voltage supply signal, wherein the power storage element includes at least one layer generally parallel to the substrate.

The integrated circuit can further include one or more of the following features: the at least one layer includes first and second conductive layers generally parallel to the substrate, and a dielectric layer disposed between the first and second conductive layers such that the first and second conductive layers and the dielectric layer form a capacitor, wherein the integrated power storage element comprises the capacitor, the integrated power storage element includes a coil formed in the at least one layer to form an inductor, a voltage regulator to receive a supply voltage and provide a regulated output voltage to the output circuit, a slot formed in at least one of the first and second conductive layers proximate a magnetic field sensor for reducing eddy currents in the first and second conductive layers, the slot includes a first slot in the first conductive layer and a second slot in the second conductive layer, wherein the first and second slots having different geometries, the slot includes a first slot in the first conductive layer and a second slot in the second conductive layer, wherein the first and second slots have substantially similar geometries, the sensor includes a Hall element, the sensor includes a magnetoresistance element, the capacitor overlaps with at least thirty percent of an area of the substrate, and the capacitor provides a capacitance from about 150 pF to about 400 pF in about 1.0 mm square.

In a further aspect of the invention, a method comprises providing a sensor to provide a sensor output, providing an integrated circuit module formed at least partially on a substrate to receive the sensor output and provide an IC output signal, providing an output circuit having a voltage input to receive a voltage supply signal via a switch element and a signal input to receive the IC output signal and an output to provide a voltage output signal, and providing an integrated power storage element coupled to the voltage input of the output circuit to provide power during an interruption of the voltage supply signal, wherein the power storage element includes at least one layer generally parallel to the substrate.

The method can further include one or more of the following features: the at least one layer includes first and second conductive layers generally parallel to the substrate, and a dielectric layer disposed between the first and second conductive layers such that the first and second conductive layers and the dielectric layer form a capacitor, wherein the integrated power storage element comprises the capacitor, the integrated power storage element includes a coil formed in the at least one layer to form an inductor, a voltage regulator to receive a supply voltage and provide a regulated output voltage to the output circuit, a slot formed in at least one of the first and second conductive layers proximate a magnetic field sensor for reducing eddy currents in the first and second conductive layers, the slot includes a first slot in the first conductive layer and a second slot in the second conductive layer, wherein the first and second slots having different geometries, the slot includes a first slot in the first conductive layer and a second slot in the second conductive layer, wherein the first and second slots have substantially similar geometries, the sensor includes a Hall element, the sensor includes a magnetoresistance element, the capacitor overlaps with at least thirty percent of an area of the substrate, and the capacitor provides a capacitance from about 150 pF to about 400 pF in about 1.0 mm square.

In a further aspect of the invention, a vehicle comprises a sensor to provide a sensor output, an integrated circuit module formed at least partially on a substrate to receive the sensor output and provide an IC output signal, an output circuit having a voltage input to receive a voltage supply signal via a switch element and a signal input to receive the IC output signal and an output to provide a voltage output signal, and an integrated power storage element coupled to the voltage input of the output circuit to provide power during an interruption of the voltage supply signal, wherein the power storage element includes at least one layer generally parallel to the substrate.

### BRIEF DESCRIPTION OF THE DRAWINGS

The foregoing features of this invention, as well as the invention itself, may be more fully understood from the following description of the drawings in which:

FIG. 1 is a schematic representation of a device having integrated energy storage for power interruption;

FIG. 1A is a further schematic representation of a device having integrated energy storage for power interruption;

FIG. 2 is a schematic representation of a power capacitor disposed over a die;

FIG. 2A is a schematic representation of a power inductor disposed over a die;

FIG. 3A is a top view of a device having an on chip power capacitor in accordance with an exemplary embodiment of the invention;

FIG. 3B is a cross-sectional view of the device of FIG. 3A taken along line A-A;

FIG. 4 is a schematic diagram of a device having multiple on chip power capacitors; and

FIG. 5 is a flow diagram showing an exemplary sequence of steps to fabricate a device having an on chip power capacitor.

FIG. 6A is a schematic depiction of an integrated circuit having multiple chips having at least one respective on-chip power capacitor;

FIG. 6B is a side view of the integrated circuit of FIG. 6A;

FIG. 6C is a pictorial representation of interdigitated on-chip power capacitors;

FIG. 7 is a pictorial representation of an integrated circuit having a first substrate with a first on-chip power capacitor and a second substrate with a second on-chip power capacitor;

FIG. 8A is a side view of a multi-chip, multi on chip power capacitor integrated circuit in a flip chip configuration;

FIG. 8B is a top view of the integrated circuit of FIG. 8A;

FIG. 9 is a schematic depiction of a device having an on chip power capacitor with a slot for eddy current reduction;

FIG. 9A is a side view of a device having an on chip power capacitor with a slot for eddy current reduction; and

FIG. 10 is a flow diagram showing an exemplary sequence of steps for providing a device with an on-chip power capacitor with eddy current reduction.

### DETAILED DESCRIPTION

In general, exemplary embodiments of the present invention provide a integrated circuit, such as a sensor, including integrated energy storage for local power during a relatively small power interruption to maintain an output state of the sensor/device. In certain applications, for example magnetic field sensing of a ferrous object, it is desirable to maintain the output state of a sensor device during small time scale power interruptions. By utilizing a relatively large integrated capacitor with circuitry under the capacitor, more die area is available while the energy stored in the capacitor, or other energy storage element, can maintain output states through short power interruptions. Exemplary power interruptions includes a loose wire or connector causing intermittent connectivity when subjected to vibrations due to movements, for example, or manipulation by a user of a handheld consumer electronics device, or a vehicle motion, for example when encountering a bump or rough road.

It is understood that exemplary embodiments of the invention are applicable to a wide variety of integrated circuits, sensors, such as magnetic field sensors and accelerometers, and products, such as vehicle sensors and consumer devices. A wide variety of applications will be readily apparent to one of ordinary skill in the art in which there is a need for a local energy source useable during power interruptions.

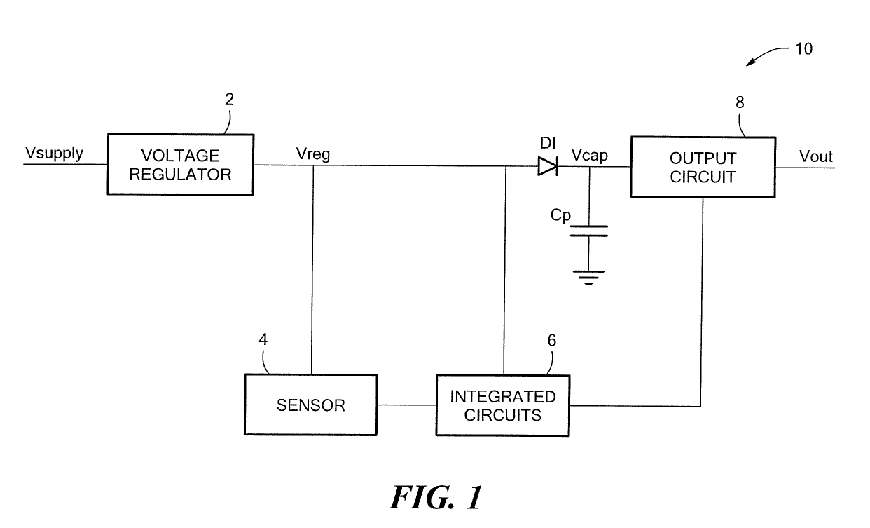

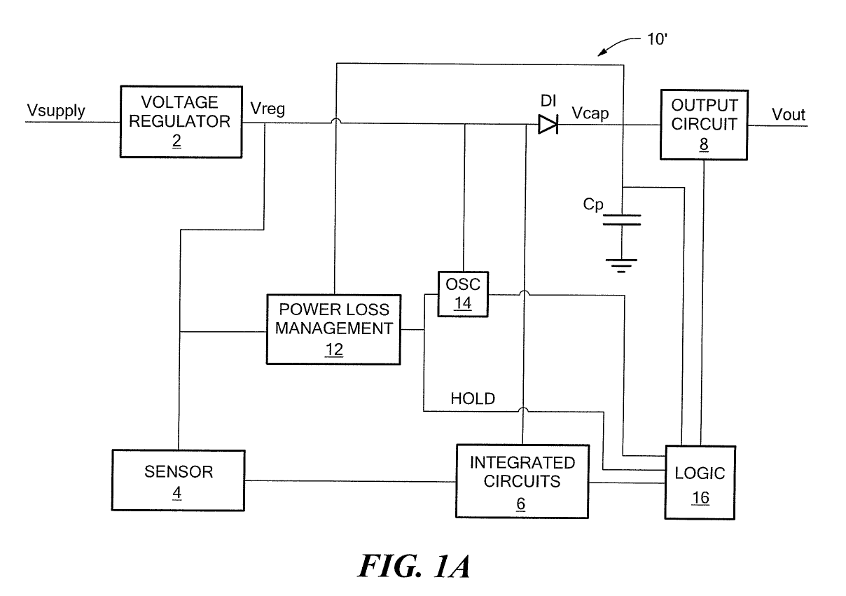

FIG. 1 shows an exemplary circuit device 10 for a sensor having integrated local energy storage to provide power during interruptions of a supply voltage. The device includes a voltage regulator 2 to receive a supply voltage signal Vsupply and output a regulated voltage Vreg. A sensor 4 powered by the regulated voltage signal Vreg provides a sensor output signal to an integrated circuit module 6, which also receives the regulated voltage signal. An output circuit 8, which provides an output signal Vout for the device, receives the regulated voltage signal Vreg via a diode D1. An integrated power capacitor Cp is coupled to a point between the cathode of the diode D1 and the output circuit 8 input.

FIG. 1A shows an a further embodiment 10′ similar to the embodiment 10 of FIG. 1 with the addition of a power loss management module 12, an oscillator 14, and a logic circuit 16. The logic circuit 16 holds the state of logic during a power loss and allows the circuit to resume where it was when power returns. The oscillator 14 can be stopped during the power loss to conserve power in the logic circuit 16. The power management circuit 12 outputs a hold signal that is active during the power loss. The hold signal is provided to the oscillator 14 and the logic circuit 16. In other embodiments the state of the logic may be used to restart the integrated circuit 6 in a known position.

It is understood that instead of a diode, any suitable switch element can be used to isolate the output circuit. It is further understood that switch element should be construed broadly to include diodes, transistors, and any type of switch that is suitable to selectively direct energy from the power storage element to a desired circuit element(s) during a power interruption. FIG. 1 shows an exemplary circuit configuration that can be readily modified by adding and/or deleting elements, altering connections, and otherwise changed to meet the needs of a particular application in a manner readily appreciated by one of ordinary skill in the art. For example, a regulated voltage may be provided indirectly to the IC circuits.

It is understood that the duration of any power interruption of the supply voltage Vsupply is relatively short, e.g., less than hundreds of milliseconds, and usually less than on the order of tens to hundreds of microseconds. In general, when the supply voltage Vsupply is present, the regulator 2 provides a constant voltage Vreg for powering the entire circuit. If the supply voltage Vsupply turns off, then the regulated voltage signal Vreg falls to some value below a desired level. In such an event, the integrated power capacitor Cp provides a constant voltage, Vcap=Vreg−˜0.7V, to the output circuit.

It is understood that a variety of other configurations than a diode may be used to achieve a similar function with a lower voltage drop than the 0.7V drop of a diode. A connection from the integrated circuits module 4 to the output circuit 8 is the input to convey the data signal to the output block.

It is understood that the size of the capacitor Cp required for local power during supply interruptions is determined by the circuit to be powered when the regulated voltage Vreg is turned off. In general, the capacitor size is relatively large compared to a conventional capacitor in an integrated circuit. In exemplary embodiments, the power capacitor Cp is on the order of hundreds of pF, for example 100 pF to 2,000 pF. The capacitance can be larger depending on the number of capacitor layers utilized. Typically, the capacitance is on the order of about 50 pF to about 500 pF for a 2 kA to 4 kA dielectric thickness in a capacitor of 1.0 mm square area. In other embodiments, the capacitance ranges from about 150 to about 400 pf. An exemplary range for area is about 0.5 mm² to about 1.5 mm². It is understood that the area can be smaller and larger than these areas.

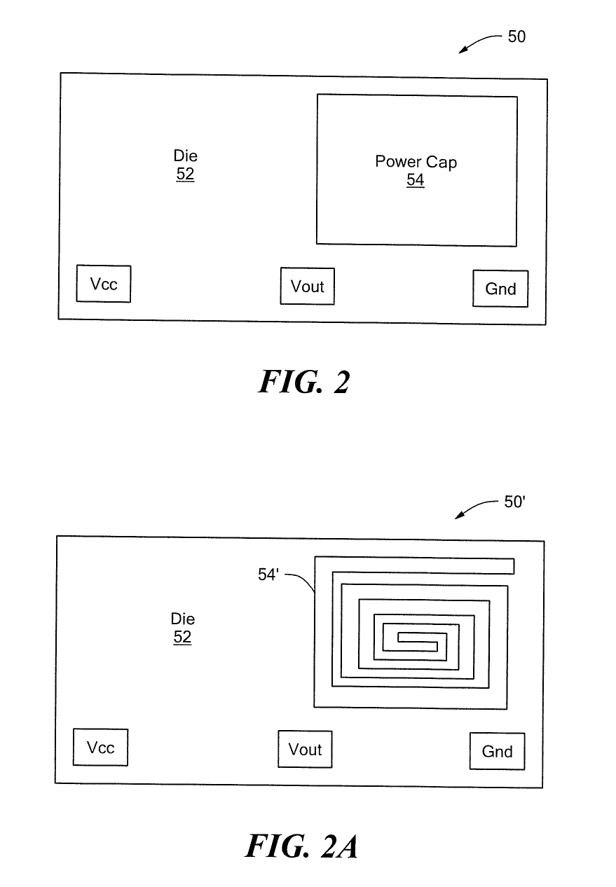

FIG. 2 shows an exemplary embodiment 50 of a die 52 having an integrated power capacitor 54 over the die. In one embodiment, the integrated power capacitor 54 covers more than 30% of the die area.

In general the integrated power capacitor Cp may be realized by adding additional metal and dielectric layers to the circuit fabrication process. As the integrated power capacitor does not require great precision in its capacitance value for certain applications, a low cost lithography process may be utilized to reduce costs of the additional layers. In some cases it may be desirable to use a process such as CMP (chemical mechanical polishing) to planarize the surface of the integrated circuit before placing the integrated power capacitor electrodes on the circuit. The CMP step may allow thinner dielectric thickness layers, which in turn will allow an increase in the device capacitance, or the same capacitance in a smaller area.

It should also be noted that multiple layers of the capacitor process may be performed to realize a larger capacitance value in a smaller die area. For example, for a 3 layer metal BiCMOS process this device would add metal 4, dielectric and metal 5, and then the final die passivation layer. In other embodiments the capacitor could be made from metal 4, dielectric, metal 5, dielectric, metal 6 and then final passivation. In general the metal layer nearest the normal metal layer of the process would be grounded to prevent any unwanted effects, for example gate leakage effects, in any underlying circuitry.

Exemplary embodiments of the invention are applicable to circuits in general in which a circuit may be put to sleep to conserve power, but the output stage should remain in the last known state. This may also be desired in certain automotive applications, or consumer electronics devices which use electrical connectors that could have an intermittent power connection, for example due to a loose wire or a loose connector. It should be noted that while FIG. 1 shows the capacitor providing power only to the output stage, it will be readily apparent to one of ordinary skill in the art that in certain other applications it may be desirable to power a memory circuit, or other sub-circuits on the die as well.

Referring again to FIG. 1, the integrated power capacitor Cp is inside of a regulated voltage, thereby protecting the capacitor Cp from any ESD, or other voltage events that may damage the dielectric of the capacitor. In other embodiments, an integrated power inductor can power a sub-circuit during a power glitch or power removal event.

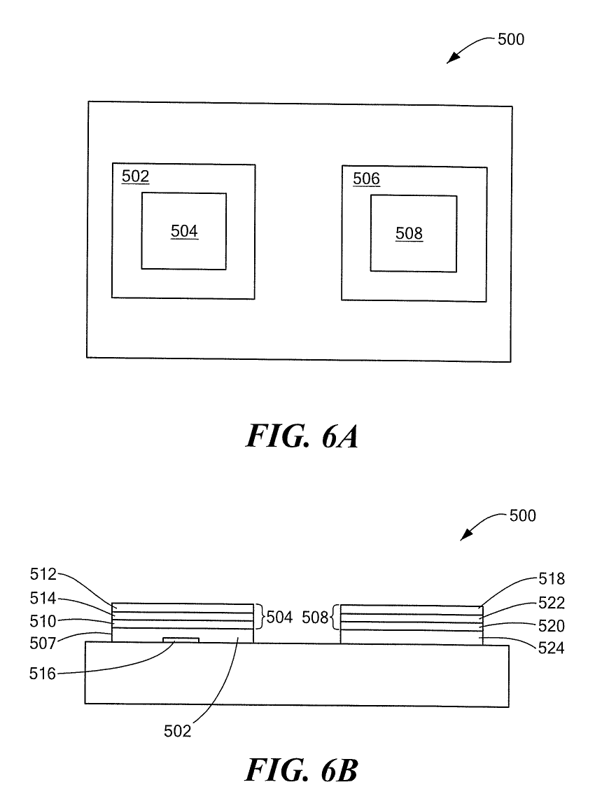

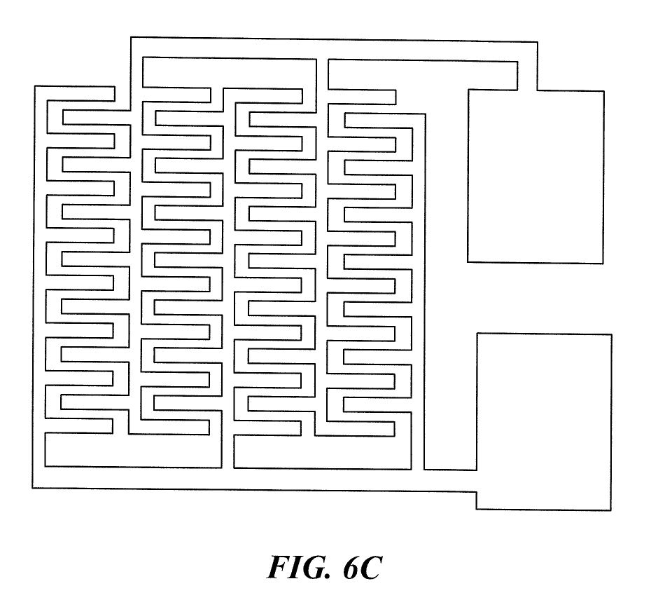

As shown in FIG. 2A, in another embodiment, an integrated energy storage element can be provided as a power inductor 54′ instead of the power capacitor 54 of FIG. 2. Fabrication of the integrated inductor 54′ can be similar to the capacitor fabrication, with the exception that the geometry of the lines to create the inductor may generally have smaller features sizes than a capacitor. It is understood that applying ferromagnetic materials to an integrated inductor can improve the inductance value. It is also understood that if implementing the use of ferromagnetic materials in connection with a magnetic field sensor, that the effects of the ferromagnetic material on the field to be sensed, or the sensor itself, should be considered in the design. This device would also be applicable to a case where the transducer element or elements, including but not limited to Hall effect, GMR, AMR, MTJ, accelerometer, pressure, chemical, biological, or temperature, are on a separate substrate than the integrated circuits used to condition the transducer signals and provide the output of the integrated circuit. An advantage of an inductor or interdigitated capacitor (see FIG. 6C infra) includes implementation with just one additional metal layer on top of the underlying circuitry.

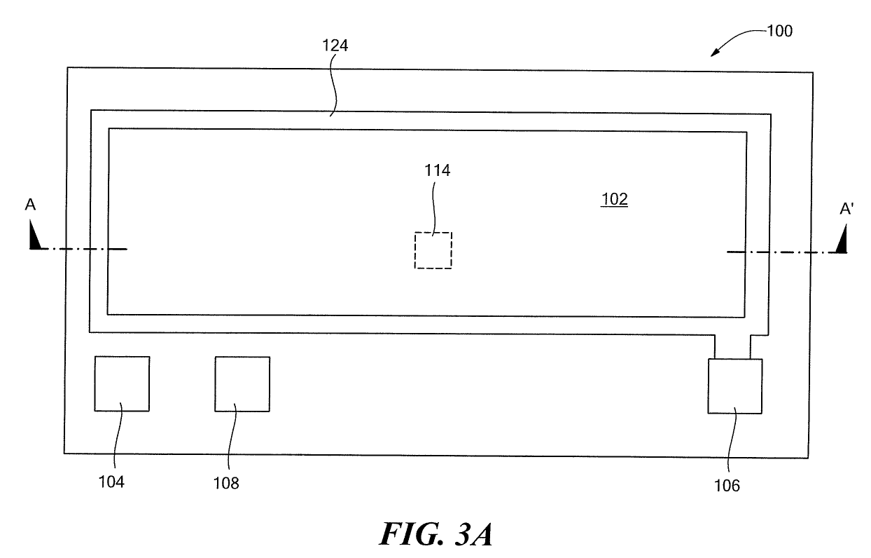

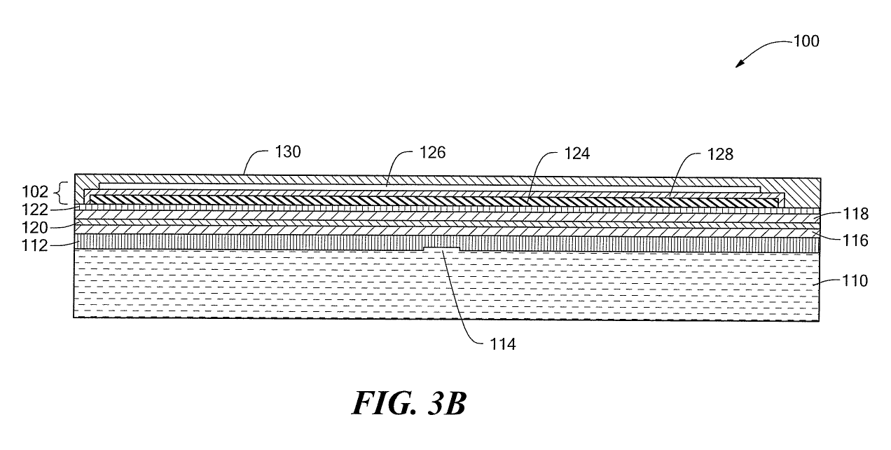

FIGS. 3A-B show an exemplary embodiment of a magnetic sensor 100 embodiment having an on chip power capacitor 102 for power interruption in accordance with the present invention. In the illustrated embodiment, the sensor 100 is a two-wire Hall effect type sensor having a VCC terminal 104 and a ground terminal 106. The capacitor 102 can store energy to provide power to an output circuit 8 (FIG. 1) or other circuits during a voltage supply power interruption.

It is understood that embodiments of the invention are applicable to a wide range of integrated circuits and sensors, such as accelerometers, pressure sensors, magnetic field sensors, for which it is desirable to address power interruptions.

A first metal layer 116 is disposed on the substrate 116 and an optional second layer 118, which is sandwiched between first and second insulating layers 120, 122, is disposed over the first metal layer 116. The first and second metal layers 116, 118 provide, for example, interconnection and routing for the device layer 112. The first and second insulating layers 120, 122 can be provided, for example, as interlayer dielectric and/or passivation layers.

First and second conductive layers 124, 126 are separated by a dielectric material 128 to form the on chip capacitor 102 above the substrate. The capacitor 102 is covered by a further insulating layer 130. In an exemplary embodiment, the capacitor 102 is separated, and electrically isolated, from the second metal layer 118 by the second insulating layer 122.

In an exemplary embodiment, a substrate or die 110, e.g., silicon, includes an integrated circuit (IC) in layers 112, 116, 120, 118, and/or 122 in which circuitry is formed in a manner well known to one of ordinary skill in the art. The device layer 112 can include a Hall element 114 that forms part of the magnetic sensor 100. The device layer may include various layers necessary to form an integrated circuit, including, but not limited to, implant or doped layers, polysilicon, epi layers, oxide, or nitride layers.

While a particular layer stack up is shown and described, it is understood that other embodiments having different layering orders and greater and fewer metal and other layers are within the scope of the invention. In addition, additional conductive layers can be added to form additional capacitors to meet the needs of a particular application.

A variety of dielectric materials for the power capacitor Cp can be used including, but not limited to; silicon nitride, silicon oxide, e.g. silicon dioxide, Tantalum oxide, Aluminum oxide, ceramics, glass, mica, polyesters (eg. Mylar), KAPTON, polyimides (e.g. Pyralin by HD Microsystems), benzocyclobutene (BCB, e.g. Cyclotene by Dow Chemical), and polynorbornene (e.g., Avatrel by Promerus). Inorganic dielectrics may be preferable for some applications based on their higher dielectric constant and the ability to create uniform thin films in the sub-micron range; e.g. 3,000 to 5,000 Angstroms in thickness.

These same dielectrics may be used where appropriate for interlayer dielectric, or final passivation materials. In the case of the interlayer dielectric, it may be advantageous to select a material that planarizes well, and has a low dielectric constant for use between the second metal layer 118 and the conductive layer 124. This should reduce any unwanted coupling of signals from lines on the metal layer 118 to the conductive layer 124, which may, for example, be a ground plane.

A variety of suitable materials can be used to provide the device layer for the sensor including silicon, gallium arsenide, silicon on insulator (SOI), and the like. In addition, various materials can be used to provide the metal layers and the conductive layers, which form the capacitor. Exemplary metal and conductive layer materials include copper, aluminum, alloys and/or other suitable metals.

It is further understood that embodiments of the invention can include the use of magnetoresistance elements. For magnetoresistance devices the sensor materials may be added on top of the substrate.

As used herein, the term die refers to a substrate, which may be a semiconductor or a semiconductor layer on an insulator, for example SOI substrates, with its associated circuits or electronic device elements. The circuits on the die may include semiconductor devices, for example diodes, and transistors, and passive devices, for example a resistor, inductor, or capacitor.

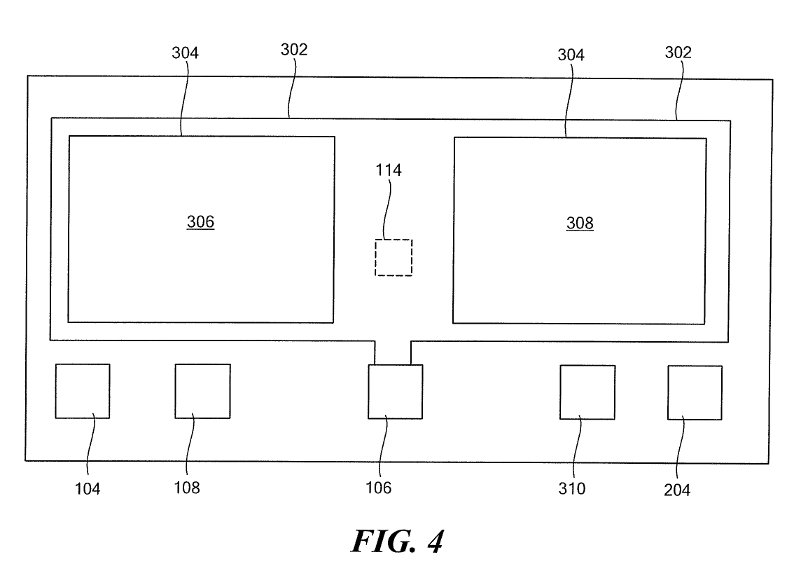

As shown in FIG. 4, the second conductive layer 304 can be separated to form multiple capacitors, shown as first and second capacitors 306, 308 in the case where the first conductive layer 302 is at the same potential for both. It would also be apparent that the first conductive layer 302 could also be split to form separate capacitors, although it may require the addition of a bonding pad depending on the application.

It is understood that the apportionment of the first and second conductive layers 302, 304 can be made to achieve capacitance requirements for a particular application. In addition, the first and second conductive layers can be split to form any practical number of capacitors above the die.

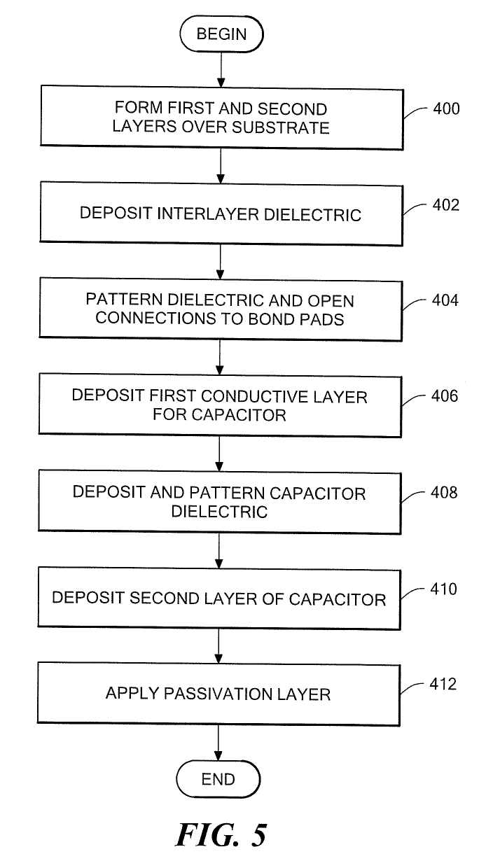

FIG. 5 shows an exemplary sequence of steps to fabricate a device having an integrated power capacitor. In general, fabrication of the integrated capacitor is performed after an integrated circuit process is performed, which may also be referred to as the base process.

In step 400, first and second metal layers are formed over a substrate. In one particular embodiment, the base process includes two metal layers for interconnection and routing and a final passivation. It may be desirable to change the final passivation on the base process, which may typically include an oxide and nitride layer. After the second metal layer, in step 402 an interlayer dielectric is deposited. Again, this is the place where the final passivation would be performed in the base process. The interlayer dielectric can be an oxide, nitride, or organic dielectric such as a polyimide, or BCB. A material such as BCB has advantages in that it planarizes the underlying substrate well and allows a flat surface for the subsequent capacitor deposition. In step 404, the interlayer dielectric is then patterned to open connections to the bond pads in the underlying integrated circuit.

In step 406, a conductive layer is then deposited on the wafer and patterned to form one of the capacitor electrodes. In the illustrated embodiment, the lower capacitor electrode is connected to a bonding pad, but not any other portions of the underlying circuit. In some cases it may be desirable to have the lower capacitor layer on the other bonding pads of the integrated circuit, although these pads are not connected to the capacitor electrode. In step 408, the capacitor dielectric is deposited and patterned. The dielectric material may be silicon nitride, or other suitable material. In step 410, the second conductive layer of the capacitor is deposited on the wafer and patterned to form the top electrode of the capacitor. Having the upper layer of the capacitor as an independent pad allows the dielectric breakdown to be tested during the final test of the integrated circuit with an on-chip capacitor. In step 412, a final passivation layer is applied to the integrated circuit with the capacitor and pattern openings for the bonding pads.

FIGS. 6A and 6B shows an exemplary integrated circuit 500 having a first die 502 having a first on-chip power capacitor 504 and a second die 506 having a second on-chip power capacitor 508. The first capacitor 504, which can be disposed above a device layer 507, can include first and second conductive layers 510, 512 with a dielectric material 514 therebetween. An optional sensor element 516 can be formed in the first die 502.

The second capacitor 508 can similarly include third and fourth conductive layers 518, 520 and an insulative layer 522. The third conductive layers 518 can be disposed over a device layer 524 for the second die 506.

The first and second capacitors 504, 508 can be covered by respective optional insulating layers (not shown).

While the first and second on-chip power capacitors are shown above the respective substrates, it is understood that in other embodiments, one or more of the on chip capacitors is below the respective substrate. In general, the conductive layers forming the on chip capacitors are generally parallel to the respective substrate. It is understood that the geometry of the capacitors can vary. For example, in another embodiment shown in FIG. 6C, one conductive layer, or multiple conductive layers, can be processed to form an on-chip interdigitated power capacitor. In one embodiment, a single conductive layer is patterned to form an on-chip interdigitated capacitor. In another embodiment, multiple conductive layers can be patterned to form one or more on-chip interdigitated capacitors. It is understood that the properties of the dielectric material used to form the capacitors factors into the impedance of the capacitor.

It is understood that in other embodiments the first die 502 can have multiple on-chip power capacitors. That is, the first and second metal layers 510, 512 can be divided, such as by etching, to form two on-chip capacitors for the first die. Similarly, the third and fourth conductive layers can be divided to provide multiple on-chip capacitors for the second die. In addition, one or both of the dies can have on-chip power capacitors. Further, embodiments are contemplated with more than two dies with at least one of the dies having an on-chip power capacitor. Other embodiments are contemplated having a variety of applications having a variety of configurations. For example, sensors, such as magnetic sensor elements, can be provided in one die, both dies, and/or multiple dies. Integrated circuits having on-chip power capacitors can be provided as a wide variety of circuit types including sensors, system on a chip, processors, and the like.

In one embodiment, the first and second dies 502, 506 are formed from the same material, such as silicon. In other embodiments, the first and second dies are formed from different materials. Exemplary materials include Si, GaAs, InP, InSb, InGaAsP, SiGe, ceramic and glass.

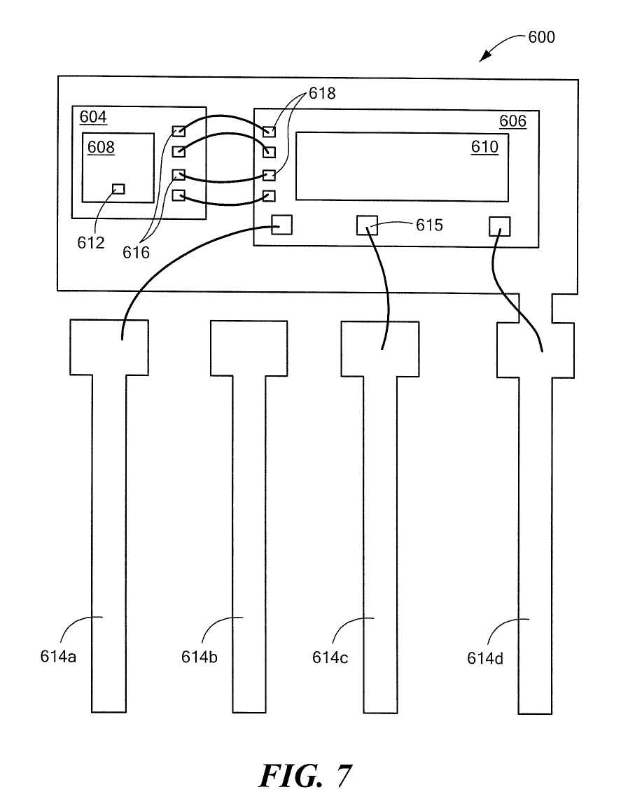

FIG. 7 shows an exemplary integrated circuit 600 having first and second dies 604, 606, each having respective on-chip power capacitors 608, 610, for providing power during voltage supply interruptions. The first die 604 includes a sensor element 612. In one particular embodiment, the sensor element is a Hall element. The second die 606 includes circuitry to support the sensor element 612 and provide output information, such as position output information for the sensor.

The integrated circuit 600 includes lead fingers 614a-d to provide input/output connections for the sensor. As described above, connections, such as wire bonds, can be made between the leadfingers 614 and input/output pads 615 on the second die 606. Connections/pads can be provided for ground, VCC, and/or signals. While not shown, it is understood that pads can also be provided for connections between the first die 604 and the lead fingers.

In other embodiments, only one of the dies has an on-chip capacitor. For example, only die 606 has an on-chip capacitor 610, die 604 does not have an on-chip capacitor.

In addition, respective first and second die pads 616, 618 enable electrical connections between the first and second dies 604, 606. It is understood that any practical number of die pads can be provided for desired connections between the dies.

It is understood that the inventive multi-die embodiments can have a variety of configurations, such as flip chip embodiments.

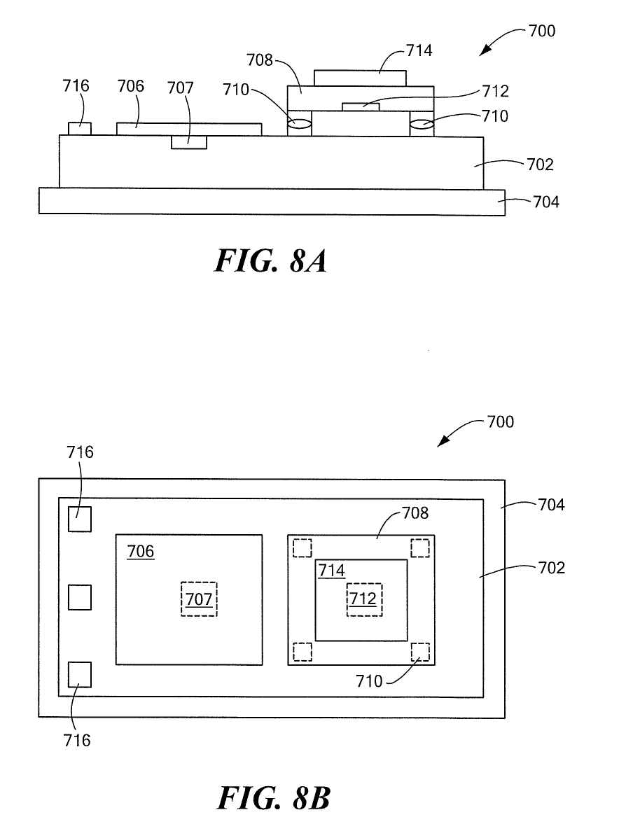

For example, FIGS. 8A and 8B show a flip-chip configuration having multiple dies with on-chip power capacitors. An integrated circuit 700 includes a first die or substrate 702 disposed on a leadframe 704. A first on-chip power capacitor 706 is formed over a portion of the first die 702. An optional sensor element 707 can be formed in the first die.

A second substrate or die 708 is coupled on top of the first die 702, such as by solder balls 710. The second die 708 can include a sensor element 712. A second on chip power capacitor 714 is disposed on the second die 708.

Bonding wires can couple bonding pads 716 to lead fingers (not shown) on the lead frame.

As noted above, the first and second dies 702, 708 can be provided as the same material or different materials. Exemplary materials include Si, GaAs, InP, InSb, InGaAsP, SiGe, ceramic and glass. Further, sensing elements in the first and second dies can be the same type of device or different types of devices. Exemplary sensor elements include Hall effect, m magnetoresistance, giant magnetresistance (GMR), anistropic magnetresistance (AMR), and tunneling magnetoresistance (TMR). The respective on chip capacitors 706, 714 can be sized to achieve a desired impedance, as discussed above.

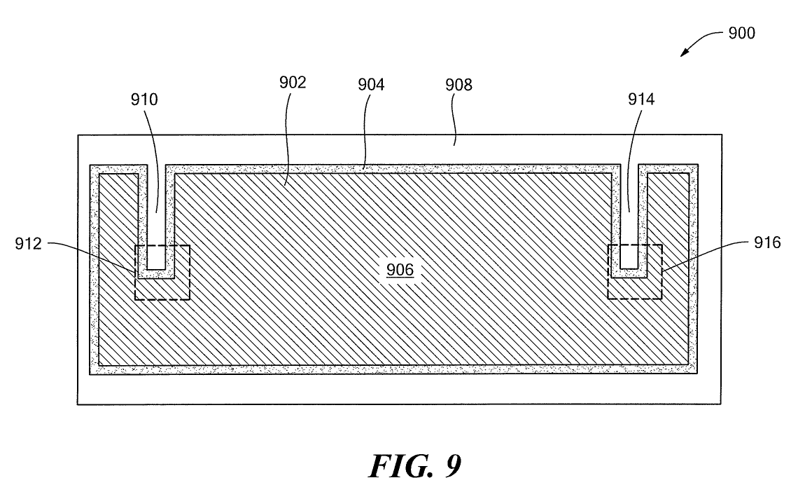

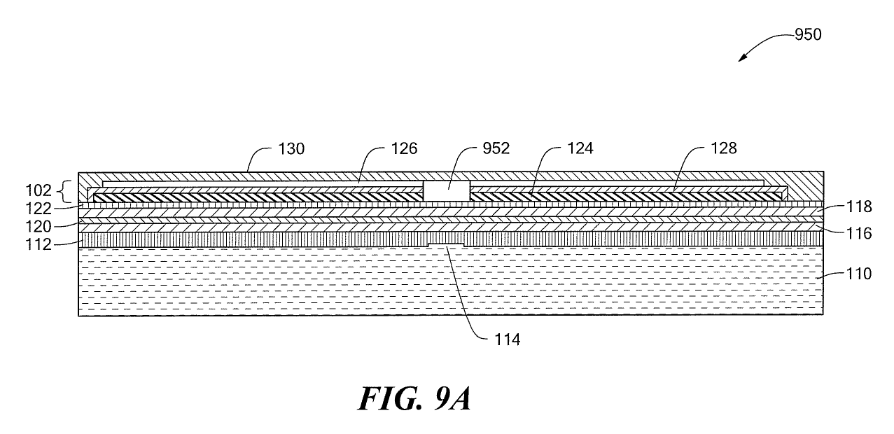

FIG. 9 shows an exemplary capacitor-on-chip capacitor power 900 having an upper layer 902 and a lower layer 904 forming a capacitor 906 over a die 908 with a first slot 910 formed in the capacitor layers to reduce eddy currents generated about a Hall element 912 in accordance with exemplary embodiments of the invention. In the illustrated embodiment a second slot 914 is formed in the capacitor layers about a second Hall element 916.

As is well known in the art, in the presence of a changing magnetic field (e.g., a magnetic field surrounding a current carrying conductor), eddy currents can be induced in the conductive layers. Eddy currents form into closed loops that tend to result in a smaller magnetic field so that a Hall effect element experiences a smaller magnetic field than it would otherwise experience, resulting in less sensitivity. Furthermore, if the magnetic field associated with the eddy current is not uniform or symmetrical about the Hall effect element, the Hall effect element might also generate an undesirable offset voltage.

The slot(s) 910 tends to reduce the total path (e.g., a diameter or path length) near the sensor, which reduces the eddy current effect of the closed loops in which the eddy currents travel in the conductive layers of the capacitor near a magnetic field sensor. It will be understood that the reduced size of the closed loops in which the eddy currents travel results in smaller eddy currents for a smaller local affect on the AC magnetic field that induced the eddy current. Therefore, the sensitivity of a current sensor or other device having a Hall effect element is less affected by eddy currents due to the slot(s).

Instead of an eddy current rotating about the Hall effect element, the slot 910 results in eddy currents to each side of the Hall element. While the magnetic fields resulting from the eddy currents are additive, the overall magnitude field strength, compared to a single eddy current with no slot, is lower due to the increased proximity of the eddy currents.

FIG. 9A shows a side cutaway view of a device 950 including an on-chip power capacitor having a slot 952 positioned in relation to a Hall element. The device 950 has some commonality with the sensor of FIG. 3B, where like reference numbers indicate like elements. The slot 952 is formed in the conductive layers 124, 126 and the dielectric layer 128 forming the capacitor.

It is understood that any number of slots can be formed in a wide variety of configurations to meet the needs of a particular application. In the illustrative embodiment, slots are formed in the capacitor layers in relation to a Hall effect element located in the die, e.g., extending from a location proximate the Hall element to an edge of the capacitor. The slots reduce the eddy current flows about a Hall element and enhance the overall performance of the sensor/device.

It is understood that the term slot should be broadly construed to cover interruptions in the conductivity of one and/or both of the capacitor layers. For example, slots can include a few relatively large holes as well as smaller holes in a relatively high density. In addition, the term slot is not intended to refer to any particular geometry. For example, slot includes a wide variety of regular and irregular shapes, such as tapers, ovals, etc. Further, it is understood that the direction/angle of the slot(s) can vary. Also, it will be apparent that it may be desirable to position the slot(s) based upon the type of sensor. It is understood that a slot can have different geometries in the upper and lower layer of the capacitor. For example, FIG. 9B shows a slot 910′ formed in only the lower layer of the on-chip capacitor. This embodiment may shield the sensor from an external noise caused by, for example another electrical wire in the vicinity of the sensor.

In general, it may be preferable to have a slot in upper and lower plates of the on-chip capacitor. It is understood, however, that a slot only the lower plate, i.e., the plate closer to the magnetic sensor, will reduce eddy currents more than a slot only in the upper plate of the capacitor since the upper plate is further away than the lower plate (assuming similar metal thicknesses), and thus, has less influence on the sensitivity of the magnetic sensor. In general, it is desirable to remove the conductors, i.e., the plates of the capacitor, over the Hall plate. A current directly over the Hall plate, or near the plate, will have more influence due to its geometry than one that is even tens of microns away.

The slots can have any practical geometry and orientation in relation to the magnetic sensor and/or die to meet the needs of a particular application. Slot 1016 is shown having one example configuration of a slot angled in relation to an edge of the capacitor.

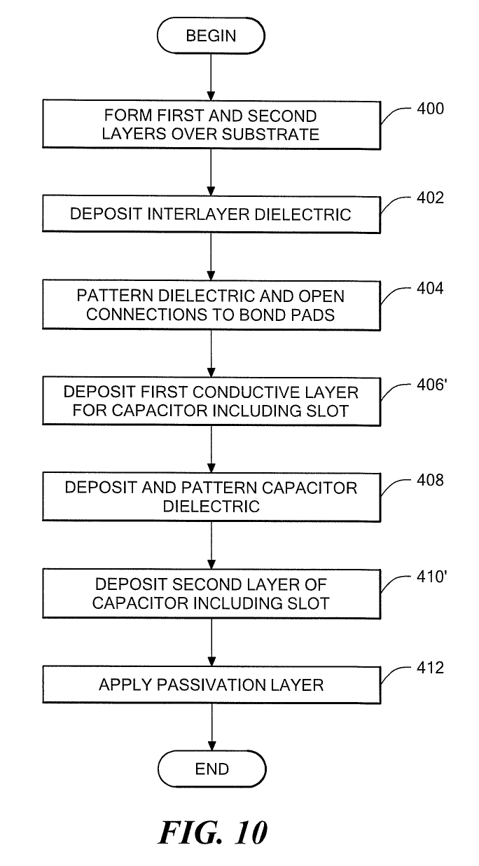

FIG. 10 shows an exemplary sequence of steps for providing eddy current reduction for an on-chip capacitor having some similarity to FIG. 5, in which like reference numbers indicate like elements. In an exemplary embodiment, step 406′ includes patterning the first conductive layer to include a slot to reduce eddy currents. Similarly, step 410′ includes patterning the second conductive layer to the slot.

It is understood that the steps in FIG. 10 can be readily modified, reordered, etc, to the meet the needs of a particular application. For example, patterning of the conductive layers and dielectric to include the slot can be provided using a single mask for each layer, or the slot can be formed after the capacitor is complete. Other such variations will be readily apparent to one of ordinary skill in the art.

While exemplary embodiments contained herein discuss the use of a device, such as a sensor, having integrated having integrated power storage for power interruptions, it will be apparent to one of ordinary skill in the art that other types of devices having a variety of magnetic field sensors may also be used in place of or in combination with a Hall element. For example the device could use an anisotropic magnetoresistance (AMR) sensor and/or a Giant Magnetoresistance (GMR) sensor. In the case of GMR sensors, the GMR element is intended to cover the range of sensors comprised of multiple material stacks, for example: linear spin valves, a tunneling magnetoresistance (TMR), magnetic tunnel junction (MTJ) or a colossal magnetoresistance (CMR) sensor. In other embodiments, the sensor includes a back bias magnet. It is understood that the terms die and substrate are used interchangeably.

While the invention is primarily shown and described in conjunction with integrated circuit sensors, and particularly magnetic sensors, it is understood that the invention is applicable to integrated circuits in general for which it is desirable to provide integrated energy storage to provide power during relatively short supply voltage interruptions. In addition, while the on-chip power capacitors are shown above a die it is understood that embodiments are contemplated in which the on chip capacitor is below the die. That is, the conductive layers forming the on-chip capacitor are generally parallel with the plane in which the die rests. In one embodiment, interdigitated electrodes could also be used to form on-chip capacitors in a single layer of metal.

It is understood that a variety of suitable fabrication processes can be used to form a sensor having an on chip capacitor including, but not limited to, bipolar, DMOS, bi-CMOS, CMOS, and processes and combinations of these and other processes

While exemplary embodiments contained herein discuss the use of a Hall effect sensor, it would be apparent to one of ordinary skill in the art that other types of magnetic field sensors may also be used in place of or in combination with a Hall element. For example the device could use an anisotropic magnetoresistance (AMR) sensor and/or a Giant Magnetoresistance (GMR) sensor. In the case of GMR sensors, the GMR element is intended to cover the range of sensors comprised of multiple material stacks, for example: linear spin valves, a tunneling magnetoresistance (TMR), or a colossal magnetoresistance (CMR) sensor. In other embodiments, the sensor includes a back bias magnet.

Having described exemplary embodiments of the invention, it will now become apparent to one of ordinary skill in the art that other embodiments incorporating their concepts may also be used. The embodiments contained herein should not be limited to disclosed embodiments but rather should be limited only by the spirit and scope of the appended claims. All publications and references cited herein are expressly incorporated herein by reference in their entirety.

What is claimed is:

1. An integrated circuit, comprising:
a sensor to provide a sensor output;
an integrated circuit module formed at least partially on a substrate to receive the sensor output and provide an IC output signal;
an output circuit having a voltage input to receive a voltage supply signal via a switch element and a signal input to receive the IC output signal and an output to provide a voltage output signal; and
an integrated power storage element coupled to the voltage input of the output circuit to provide power during an interruption of the voltage supply signal, wherein the power storage element includes at least one layer generally parallel to the substrate.

2. The integrated circuit according to claim 1, wherein the at least one layer includes
first and second conductive layers generally parallel to the substrate; and
a dielectric layer disposed between the first and second conductive layers such that the first and second conductive layers and the dielectric layer form a capacitor, wherein the integrated power storage element comprises the capacitor.

3. The integrated circuit according to claim 2, wherein the capacitor includes an interdigitated structure.

4. The integrated circuit according to claim 1, wherein the integrated power storage element includes a coil formed in the at least one layer to form an inductor.

5. The integrated circuit according to claim 1, further including a voltage regulator to receive a supply voltage and provide a regulated output voltage to the output circuit.

6. The integrated circuit according to claim 2, wherein a slot is formed in at least one of the first and second conductive layers proximate a magnetic field sensor for reducing eddy currents in the first and second conductive layers.

7. The integrated circuit according to claim 6, wherein the slot includes a first slot in the first conductive layer and a second slot in the second conductive layer, wherein the first and second slots having different geometries.

8. The integrated circuit according to claim 6, wherein the slot includes a first slot in the first conductive layer and a second slot in the second conductive layer, wherein the first and second slots have substantially similar geometries

9. The integrated circuit according to claim 1, wherein the sensor includes a Hall element.

10. The integrated circuit according to claim 1, wherein the sensor includes a magnetoresistance element.

11. The integrated circuit according to claim 2, wherein the capacitor overlaps with at least thirty percent of an area of the substrate.

12. The integrated circuit according to claim 2, wherein the capacitor provides a capacitance from about 50 pF to about 500 pF in about 1.0 mm square.

13. The integrated circuit according to claim 2, wherein the capacitance provides a capacitance from about 150 pF to about 400 pF.

14. A method comprising:
providing a sensor to provide a sensor output;
providing an integrated circuit module formed at least partially on a substrate to receive the sensor output and provide an IC output signal;
providing an output circuit having a voltage input to receive a voltage supply signal via a switch element and a signal input to receive the IC output signal and an output to provide a voltage output signal; and
providing an integrated power storage element coupled to the voltage input of the output circuit to provide power during an interruption of the voltage supply signal, wherein the power storage element includes at least one layer generally parallel to the substrate.

15. The method according to claim 14, wherein the at least one layer includes
first and second conductive layers generally parallel to the substrate; and
a dielectric layer disposed between the first and second conductive layers such that the first and second conductive layers and the dielectric layer form a capacitor, wherein the integrated power storage element comprises the capacitor.

16. The method according to claim 15, wherein the capacitor is at least partially interdigitated.

17. The method according to claim 14, wherein the integrated power storage element includes a coil formed in the at least one layer to form an inductor.

18. The method according to claim 14, further including a voltage regulator to receive a supply voltage and provide a regulated output voltage to the output circuit.

19. The method according to claim 15, wherein a slot is formed in at least one of the first and second conductive layers proximate a magnetic field sensor for reducing eddy currents in the first and second conductive layers.

20. The method according to claim 19, wherein the slot includes a first slot in the first conductive layer and a second slot in the second conductive layer, wherein the first and second slots having different geometries.

21. The method according to claim 19, wherein the slot includes a first slot in the first conductive layer and a second slot in the second conductive layer, wherein the first and second slots have substantially similar geometries

22. The method according to claim 14, wherein the sensor includes a Hall element.

23. The method according to claim 14, wherein the sensor includes a magnetoresistance element.

24. The method according to claim 15, wherein the capacitor overlaps with at least thirty percent of an area of the substrate.

25. The method according to claim 15, wherein the capacitor provides a capacitance from about 150 pF to about 400 pF in about 1.0 mm square.

26. A vehicle, comprising:
a sensor to provide a sensor output;
an integrated circuit module formed at least partially on a substrate to receive the sensor output and provide an IC output signal;
an output circuit having a voltage input to receive a voltage supply signal via a switch element and a signal input to receive the IC output signal and an output to provide a voltage output signal; and
an integrated power storage element coupled to the voltage input of the output circuit to provide power during an interruption of the voltage supply signal, wherein the power storage element includes at least one layer generally parallel to the substrate.

27. The vehicle according to claim 26, wherein the at least one layer includes
first and second conductive layers generally parallel to the substrate; and
a dielectric layer disposed between the first and second conductive layers such that the first and second conductive layers and the dielectic layer form a capacitor, wherein the integrated power storage element comprises the capacitor.

28. The vehicle according to claim 26, wherein the integrated power storage element includes a coil formed in the at least one layer to form an inductor.
